(19) United States
(12) Patent Application Publication
(10) Pub. No.: US 2015/0134729 A1
(43) Pub. Date: May 14, 2015

(54) METHOD AND APPARATUS FOR MANAGING SERVICE CAPABILITY THROUGH NETWORK

(71) Applicant: ELECTRONICS AND TELECOMMUNICATIONS RESEARCH INSTITUTE, Daejeon (KR)

(72) Inventors: Sunhwan LIM, Daejeon (KR); Hyun Joo BAE, Daejeon (KR)

(73) Assignee: ELECTRONICS AND TELECOMMUNICATIONS RESEARCH INSTITUTE, Daejeon (KR)

(21) Appl. No.: 14/198,688

(22) Filed: Mar. 6, 2014

(30) Foreign Application Priority Data
Nov. 8, 2013 (KR) 10-2013-0135826

(51) Int. Cl. H04L 29/08

(52) U.S. Cl. CPC H04L 67/16; H04L 67/02
USPC 709/203

(57) ABSTRACT

In order to provide service capability management to a service application server that is connected to a user terminal through a network, a service capability management apparatus receives a service capability management request of a communication network resource from the service application server. The service capability management apparatus transmits a request processing result including a uniform resource locator (URL) that is related to a processing result of a corresponding communication network resource to a service application server according to the request. The service capability management apparatus communicates with the service application server through an open interface using a representational state transferful (RESTful) web service.

### CROSS-REFERENCE TO RELATED APPLICATION

This application claims priority to and the benefit of Korean Patent Application No. 10-2013-0135826 filed in the Korean Intellectual Property Office on Nov. 8, 2013, the entire contents of which are incorporated herein by reference.

### BACKGROUND OF THE INVENTION

(a) Field of the Invention

The present invention relates to a method and system for managing a service capability. More particularly, the present invention relates to a method and apparatus for managing a service capability that is provided through a network.

(b) Description of the Related Art

Communication network abstraction technology supports generation of a “telecom-enabled” application, and is core technology that enables provision of various integration services regardless of characteristics and a form of a lower transport network. The technology has been developed from a protocol-based technology to an application programming interface (API)-based technology and a script language-based technology and thus the number of provided capabilities was relatively reduced, but the number of necessary developers has been increased.

In order to develop more various services and to secure many developers, a simple object access protocol (SOAP)-based web service was opened. A SOAP-based web service uses a hypertext transfer protocol (HTTP) application protocol and a message thereof is formed with a SOAP header and body, and when transmitting and receiving a message, an encoding/decoding process of a header and a body is essential. Therefore, in an Internet service field that has transferred a message with a basic HTTP, there is a problem that an overhead occurs when processing a SOAP protocol rather than a desired capability.

Unlike such a SOAP, a RESTful web service, which is a representational state transfer (REST)-based web service, enables an IT application developer having no detailed knowledge on a communication network protocol with web application technology that accesses remote information with only a basic capability of an HTTP to simply access a communication network resource.

A demand for a SOAP-based web service was started for a mutual operation between application services in a business environment of a corporation, whereas a RESTful web service was started to enable Internet service companies to easily provide data to application developers. Therefore, a SOAP-based web service was developed according to strict grammar so that a program (or apparatuses) that provides and uses a service may be well understand, and relatively higher difficulty of programming ability that should entail all know various web service basic specifications was requested of developers. Accordingly, nowadays, for convenience of SOAP-based web service development, an attempt for supporting various development environments has been performed.

However, in order for a person rather than a machine to easily understand, a RESTful web service does not require a separate development/execution environment in addition to Internet basic (HTTP and javascript object notation (JSON)). Particularly, Internet service companies that provide a RESTful web service also provide a service mashup environment free of charge, and thus the number of developers is widely expanded. Accordingly, development of technology that can provide and manage various services based on a RESTful web service is requested.

### SUMMARY OF THE INVENTION

The present invention has been made in an effort to provide a method and apparatus for providing and managing various service capabilities using an open interface using a RESTful web service, when processing management of a service capability that application service logic that is connected to a network requests.

An exemplary embodiment of the present invention provides a method of providing service capability management to a service application server that is connected to a user terminal through a network, the method including: receiving, by a service capability management apparatus, a service capability management request for a communication network resource from the service application server; and transmitting, by the service capability management apparatus, a request processing result including a uniform resource locator (URL) that is related to a processing result of a corresponding communication network resource to the service application server according to the request, wherein the service capability management apparatus communicates with the service application server through an open interface using a representational state transferful (RESTful) web service.

The transmitting of a request processing result may include: transferring, by the service capability management apparatus, the request to a service capability providing server of a communication network; receiving, by the service capability management apparatus, a URL that is related to the processing result from the service capability providing server; and transmitting, by the service capability management apparatus, a request processing result including a URL that is related to a processing result to the service application server.

The communication network resource may be a resource for a service capability management open service through the service capability management apparatus, and may include a first resource, which is a service providing capability information list, a second resource, which is individual service providing capability information, and a third resource, which is a service providing capability information list of contact.

The transmitting of a request processing result may include at least one of: transmitting, by the service capability management apparatus, an inquiry result including a URL of an entire service capability information list that is provided through the service capability providing server to the service application server, when receiving a service capability management request using a first method for the first resource; generating, by the service capability management apparatus, new service capability information through the service capability providing server and transmitting a processing result including an identifier and a related URL of the generated service capability information to the service application server, when receiving a service capability management request using a second method for the first resource; updating, by the service capability management apparatus, corresponding service capability information through the service capability providing server and transmitting a processing result including a related URL of the updated service capability information to the service application server, when receiving a service capability management request using a third method for the first resource; and deleting, by the service capability management apparatus, corresponding service capability information through the service capability providing server and transmitting a deletion result to the service application server, when receiving a service capability management request using a fourth method for the first resource.

The transmitting of a request processing result may include at least one of: transmitting, by the service capability management apparatus, an inquiry result including a URL of corresponding service capability information through the service capability providing server to the service application server, when receiving a service capability management request using a first method for the second resource; updating, by the service capability management apparatus, corresponding service capability information through the service capability providing server and transmitting a processing result including a related URL of the updated service capability information to the service application server, when receiving a service capability management request using a third method for the second resource; and deleting, by the service capability management apparatus, corresponding service capability information through the service capability providing server and transmitting a deletion result to the service application server, when receiving a service capability management request using a fourth method for the second resource.

The method may further include performing, by the service capability management apparatus, activation and inactivation of corresponding service capability information, when receiving a service capability management request using the third method.

The transmitting of a request processing result may include transmitting, by the service capability management apparatus, an inquiry result including a URL of service capability information for corresponding contact to the service application server through the service capability providing server to the service application server, when receiving a service capability management request using a first method for the third resource.

Another embodiment of the present invention provides a service capability management apparatus that provides service capability management to a service application server that is connected to a user terminal through a network, the service capability management apparatus including: a web service processor that communicates with the service application server through an open interface using a representational state transferful (RESTful) web service and that receives a service capability management request of a communication network resource from the service application server and that transmits a processing result of the request to the service application server; and a capability management processor that transfers the service capability management request to a service capability providing server that is located at a communication network and that receives a uniform resource locator (URL) that is related to a processing result of the request to transfer the URL to the web service processor, wherein the web service processor provides the processing result of the request including the URL to the service application server.

The communication network resource may be a resource for a service capability management open service through the service capability management apparatus, and may include a first resource, which is a service providing capability information list, a second resource, which is individual service providing capability information, and a third resource, which is a service providing capability information list of contact.

The capability management processor may include: a management server unit that generates and registers an object for processing a request according to the request of the open service application server; a protocol stack implementation unit that transfers the request to the service capability providing server by interlocking with the service capability providing server and that receives a processing result; and a management implementation unit that operates by an object that is generated by the management server unit and that transfers the request to the protocol stack implementation unit and that receives the processing result from the protocol stack implementation unit to provide the processing result to the web service processor.

The service capability management request may include at least one of a first method that requests an inquiry of the first resource, a second method that requests generation of the first resource, a third method that requests update of the first resource, and a fourth method that requests deletion of the first resource, when the service capability management request for the communication network resource is a request for the first resource.

The service capability management request may include at least one of a first method that requests an inquiry of the second resource, a third method that requests update of the second resource, and a fourth method that requests deletion of the second resource, when the service capability management request of the communication network resource is a request for the second resource.

The service capability management request may include a first method that requests an inquiry of the second resource, when the service capability management request for the communication network resource is a request for the third resource.

The service capability management apparatus may be an open service gateway apparatus for providing service capability management of the application server.

### BRIEF DESCRIPTION OF THE DRAWINGS

FIG. 1 is a diagram illustrating a network environment of a service capability management apparatus through a network according to an exemplary embodiment of the present invention.

FIG. 2 is a block diagram illustrating a structure of an open service application server according to an exemplary embodiment of the present invention.

FIG. 3 is a diagram illustrating a structure of a service capability management apparatus according to an exemplary embodiment of the present invention.

FIG. 4 is a flowchart illustrating a method of managing a service capability according to a first exemplary embodiment of the present invention.

FIG. 5 is a flowchart illustrating a method of managing a service capability according to a second exemplary embodiment of the present invention.

FIG. 6 is a flowchart illustrating a method of managing a service capability according to a third exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in an entire specification, unless explicitly described to the contrary, the word “comprise” and variations such as “comprises” or “comprising” will be understood to imply the inclusion of stated elements but not the exclusion of any other elements.

Hereinafter, a method and apparatus for managing a service capability through a network according to an exemplary embodiment of the present invention will be described with reference to the drawings.

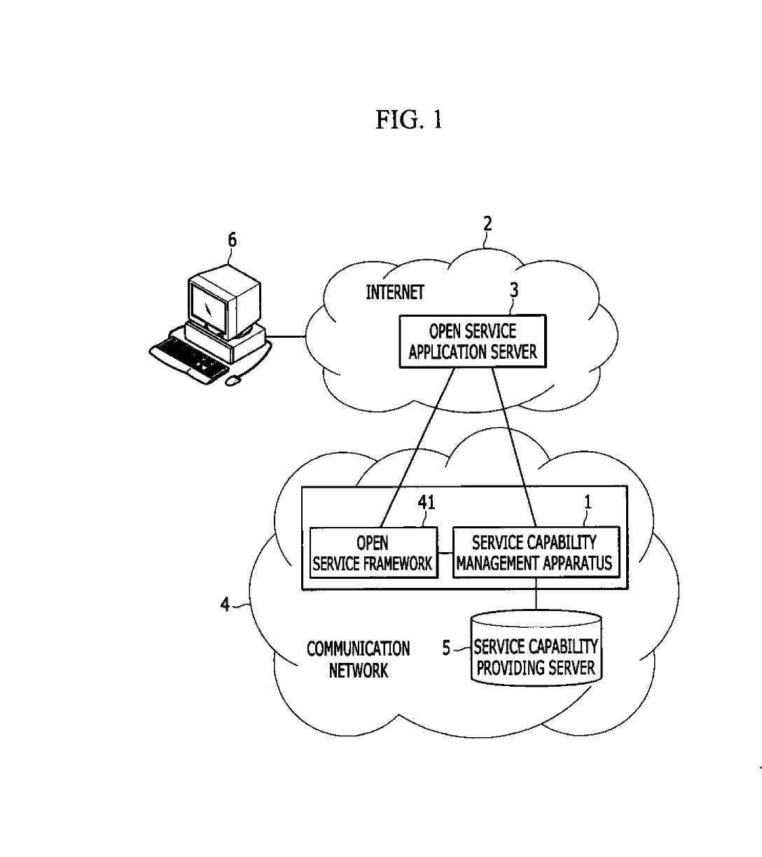

FIG. 1 is a diagram illustrating a network environment of a service capability management apparatus through a network according to an exemplary embodiment of the present invention.

As shown in FIG. 1, a service capability management apparatus 1 through a network according to an exemplary embodiment of the present invention provides a service capability to an open service application server 3 by connecting to a service capability providing server 5 that is located at a communication network 4 according to a request from the open service application server 3 that provides an open service on a network 2 such as the Internet. A user terminal 6 receives a service from the open service application server 3.

Such a service capability management apparatus 1 is located at the communication network 4 and functions as an open service gateway apparatus for providing a service capability to the open service application server 3 on the network 2.

The open service application server 3 introduces an open service interface based on an open service framework 41 that a provider of the communication network 4 provides and requests a service capability search of contact from the service capability management apparatus 1, which is an open service gateway apparatus based on the open service interface.

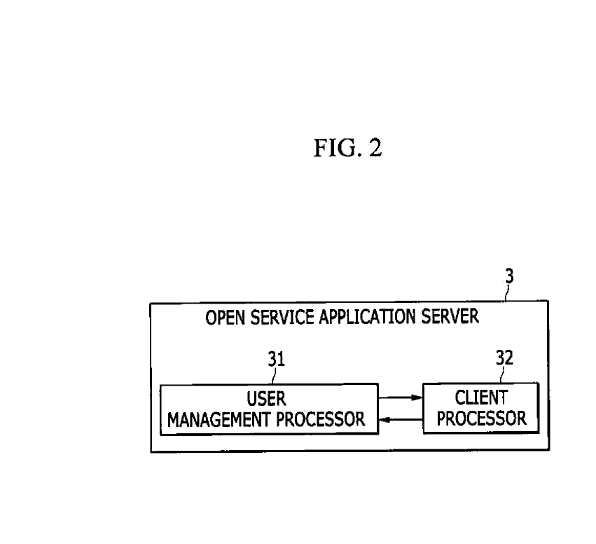

FIG. 2 is a block diagram illustrating a structure of an open service application server according to an exemplary embodiment of the present invention.

The open service application server 3 according to an exemplary embodiment of the present invention is a web site in which a management application program of a providing service capability is loaded and includes a user management processor 31 that enables a user to subscribe and log-in to a web site, and a client processor 32 that calls a service capability management resource to the service capability management apparatus 1.

The client processor 32 functions as a RESTful web service client program module that calls a service capability management resource.

The service capability providing server 5 performs a search according to a service capability search request that is transferred from the service capability management apparatus 1, and provides a found service capability to the service capability management apparatus 1.

The service capability management apparatus 1 transfers the found service capability to the open service application server 3. Further, the service capability management apparatus 1 performs registration and deletion of service capability information, and performs activation and inactivation of the registered service capability.

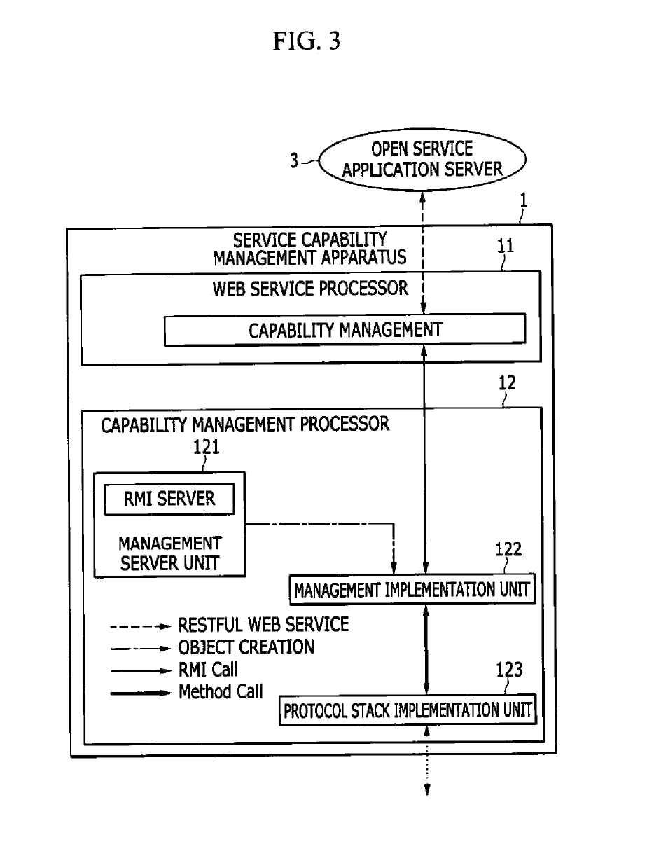

FIG. 3 is a diagram illustrating a structure of a service capability management apparatus according to an exemplary embodiment of the present invention.

As shown in FIG. 3, the service capability management apparatus 1 according to an exemplary embodiment of the present invention includes a web service processor 11 and a capability management processor (it may be also referred to as a providing capability management processor) 12.

The web service processor 11 functions as a service providing capability management RESTful web service processor, receives a request from the open service application server 3, transfers the request to the capability management processor 12, receives a result according to the request from the capability management processor 12, and transfers the result to the open service application server 3. The web service processor 11 processes a request message, i.e., a REST message, and performs a capability of transferring a request from the open service application server 3 to an appropriate remote method invocation (RMI) server.

The capability management processor 12 operates as a main processor that performs entire management of a process of providing a service capability, and includes a management server unit 121, a management implementation unit 122, and a protocol stack implementation unit 123.

The management server unit 121 generates and registers an object for processing a request according to the request of the open service application server 3. Specifically, the management server unit 121 receives an RMI request from the web service processor 11, generates an RMI server as an object for processing the request, and registers the RMI server at an RMI registry. Such a management server unit 121 functions as an always-existing main thread so as to perform a main processor capability.

The management implementation unit 122 receives a request of one time, processes and returns information of one time, and calls the protocol stack implementation unit 123 so as to interlock with the service capability providing server 5. Such a management implementation unit 122 may be generated and operated by an RMI server that is generated by the management server unit 121, and may be terminated after processing and returning information of one time. The RMI server searches for an instance corresponding to an RMI request, and may generate the management implementation unit 122 for this purpose.

The protocol stack implementation unit 123 interlocks with the service capability providing server 5 for management of capabilities that provide a service.

A resource, i.e., a service capability management resource, for an open management service of service capabilities that are provided in the service capability management apparatus 1 that is formed with such a structure is as follows.

TABLE 1

| | Base URL: http://{server | | | | |
|---|---|---|---|---|---|
| | root}/{api | HTTP verbs | | | |
| Resource | version}/capabilitymgmt)/ | GET | PUT | POST | DELETE |
| Capabilities | /capabilities | This | no | This | no |
| R1 | | operation | | operation | |
| | | returns | | creates a | |
| | | capabilities | | capability | |
| Individual | /capabilities/{capabilityId} | This | This | no | This |
| capability | | operation | operation | | operation |
| R2 | | returns | updates | | removes a |
| | | a capability | a capability | | capability |
| Capabilities | /capabilities/{contactId} | This | no | no | no |
| for a | | operation | | | |
| contact | | returns | | | |
| R3 | | capabilities | | | |
| | | for a contact | | | |

In order to request management of a service capability that is provided to the service capability management apparatus 1, which is an open service gateway, application service logic of the open service application server 3 uses a service capability management resource.

A defined service capability management resource is formed with a service capability information list R1, individual service capability information R2, and a service capability information list R3 of contact, as shown in Table 1.

An entire resource has an intrinsic uniform resource locator (URL) thereof, and may be accessed with only GET (READ), PUT (UPDATE), POST (CREATE), and DELETE, which are basic methods of an HTTP.

A first resource (capabilities resource), which is a service capability information list R1, acquires information regarding an entire service capability that is provided using a GET method and generates new service capability information using a POST method.

A second resource (individual capabilities resource), which is individual service capability information R2 and individually acquires information regarding a service capability using a GET method, updates (e.g., including activation and inactivation of a registered service providing capability) individual service capability information using an UPDATE method, and deletes individual service capability information using a DELETE method.

A third resource (capabilities for a contact resource), which is a service capability information list R3 of contact acquires information regarding an entire service capability for contact using a GET method.

Hereinafter, a method of managing a service capability according to an exemplary embodiment of the present invention will be described based on such a structure.

In an exemplary embodiment of the present invention, a method of managing a service capability for an open service for managing capabilities of providing a service through a network, i.e., a service providing capability management open service (hereinafter, for better comprehension and ease of description, referred to as a “management open service”) will be described.

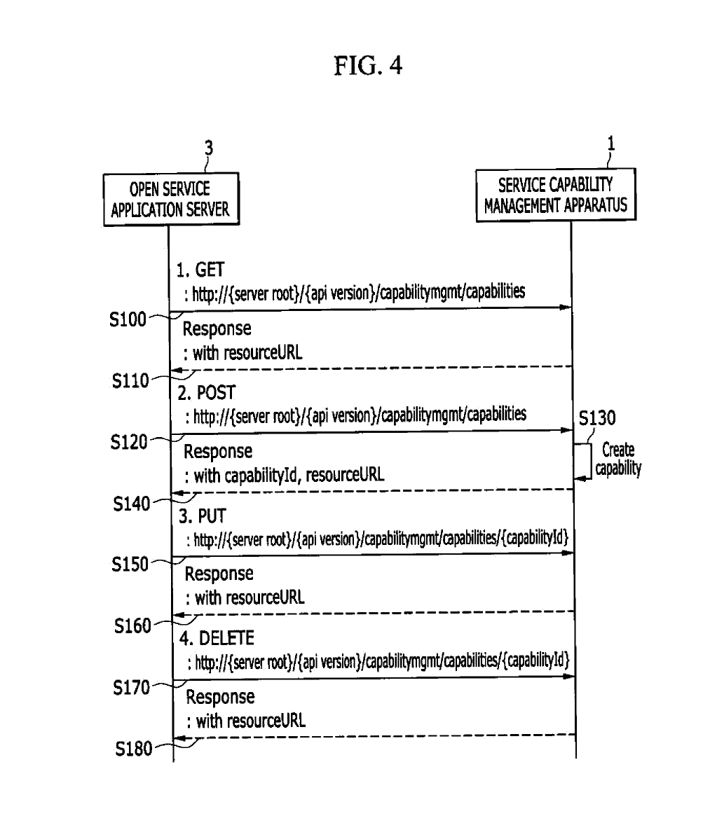

FIG. 4 is a flowchart illustrating a method of managing a service capability according to a first exemplary embodiment of the present invention.

Here, a process of generating a service capability of a management open service based on a first resource (capabilities resource), which is a service capability information list R1, and inquiring, generating, updating, and deleting service capability information will be described.

As shown in FIG. 4, the open service application server 3, which is a web site on the network 2, may request inquiry, generation, update, and deletion of service capability information to the service capability management apparatus 1, which is an open service gateway, and receive a service corresponding thereto, and a corresponding process may be performed according to a request of a random application of the open service application server 3.

When inquiring of a service capability information list, the open service application server 3 requests a service capability inquiry from the service capability management apparatus 1 using a first method, i.e., a GET method of a resource that is defined like Table 1 (S100). Here, in order to request the first resource (capabilities resource), which is a service capability information list R1, an application of the open service application server 3 generates a request message “http://{serverroot}/{apiversion}/capabilitymgmt/capabilities” using a GET method and transmits the request message to the service capability management apparatus 1.

The service capability management apparatus 1 receives a request message from the open service application server 3, and requests information regarding a service capability corresponding to the received request from the service capability providing server 5 of the communication network 4. The service capability management apparatus 1 transfers a resource URL of the first resource (capabilities resource) that is provided from the service capability providing server 5 to the open service application server 3 (S110).

Here, the capability management processor 12 of the service capability management apparatus 1 generates and registers an RMI server for processing a request according to the request of the open service application server 3, and the RMI server generates a management implementation unit 122 and requests to process a received request. Accordingly, in order to process the received request, the generated management implementation unit 122 calls the protocol stack implementation unit 123 and transfers the received request to the service capability providing server 5. The service capability providing server 5 transfers a URL corresponding to information regarding service capabilities corresponding to the received request, i.e., “Capabilities” to the service capability management apparatus 1. Accordingly, a result including a URL of the service capability information list R1 through the service capability management apparatus 1 is transferred to the open service application server 3.

The open service application server 3 receives a service providing capability inquiry result through such a process.

When generating service capability information, the open service application server 3 requests generation of service capability information from the service capability management apparatus 1 using a second method, i.e., a POST method of a defined resource (S120).

When a request message using a POST method is received, the service capability management apparatus 1 generates new service capability information, which is information regarding a new service capability. Specifically, the service capability management apparatus 1 transfers the received request message to the service capability providing server 5 and requests generation of new service capability information, and thus the service capability providing server 5 generates new service capability information and transfers an identifier (service capability information ID) regarding the generated new service capability information and a related URL to the service capability management apparatus 1 (S130).

The service capability management apparatus 1 transfers a service capability information generation result including the received service capability information ID and an related URL to the open service application server 3 (S140).

When updating service capability related information, the open service application server 3 requests update of service capability information from the service capability management apparatus 1 using a third method, i.e., a PUT method of a defined resource (S150).

A request message using a PUT method includes an identifier (capabilityId) regarding service capability information to update such as “http://{serverroot}/{apiversion}/capabilitymgmt/capabilities/capabilityId”.

When a request message using a PUT method is received, the service capability management apparatus 1 updates information regarding a corresponding service capability. Specifically, the service capability management apparatus 1 transfers the received request message to the service capability providing server 5 and requests to update information of a corresponding service capability. Accordingly, the service capability providing server 5 updates information regarding the requested service capability and transfers a resource URL that is related to the updated service capability information to the service capability management apparatus 1.

Therefore, the open service application server 3 receives a service capability information update result including a related resource URL regarding service capability information that is requested to be updated through the service capability management apparatus 1 (S160).

Further, when deleting service capability information, the open service application server 3 requests deletion of service capability information by the service capability management apparatus 1 using a fourth method, i.e., a DELETE method of a defined resource (S170). In this case, a request message using a DELETE method includes an identifier (capabilityId) of service capability information to delete such as “http://{serverroot}/{apiversion}/capabilitymgmt/capabilities/capabilityId”.

When a request message using a DELETE method is received, the service capability management apparatus 1 deletes corresponding service capability information. Specifically, the service capability management apparatus 1 transfers the received request message to the service capability providing server 5 and requests to delete information regarding a corresponding service capability. Accordingly, the service capability providing server 5 deletes information regarding a requested service capability and transfers a deletion processing result to the service capability management apparatus 1.

Accordingly, the open service application server 3 receives a deletion processing result of service capability information that requests update through the service capability management apparatus 1 (S180).

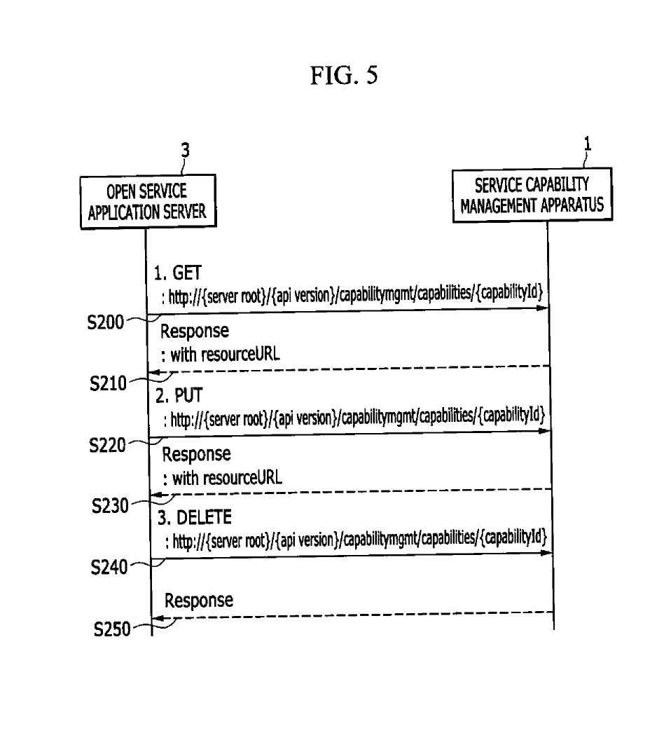

FIG. 5 is a flowchart illustrating a method of managing a service capability according to a second exemplary embodiment of the present invention.

Here, a process of inquiring, updating, and deleting service capability information on a service capability basis based on a second resource (individual capabilities resource), which is individual service capability information R2, will be described. Update includes activation and inactivation of a service capability.

As shown in FIG. 5, the open service application server 3, which is a web site on the network 2, may individually request information inquiry, update, and deletion on a service capability basis from the service capability management apparatus 1, which is an open service gateway, and receive a service corresponding thereto, and a corresponding process may be performed according to a request of a random application of the open service application server 3. A detailed description of processes that are performed similarly to the first exemplary embodiment will be omitted.

When attempting to inquire about information regarding a random service capability, the open service application server 3 requests a service capability inquiry from the service capability management apparatus 1 using a GET method, which is a first method of a defined resource (S200), as shown in Table 1. Here, the request message includes ID of a service capability to inquire about such as “http://{serverroot}/{apiversion}/capabilitymgmt/capabilities/capabilityId”. When requesting a service capability of individual service capability information, a message including an identifier of a corresponding service capability is transmitted.

The service capability management apparatus 1 receives a request message from the open service application server 3, receives information regarding a service capability corresponding to the received request from the service capability providing server 5, and transfers an inquiry result to the open service application server 3 (S210). Thereafter, the open service application server 3 receives a service providing capability inquiry result including a URL regarding service capability information that is the subject of inquiry.

When updating (including activation and inactivation) individual service capability information, the open service application server 3 transmits a message including an identifier regarding a service capability to update to the service capability management apparatus 1 using a PUT method, and requests update of individual service capability information (S220).

When a request message using a PUT method is received, the service capability management apparatus 1 updates information regarding a corresponding service capability through the service capability providing server 5. The service capability management apparatus 1 transmits an updated process result including a resource URL that is related to updated service capability information that is provided from the service capability providing server 5 to the open application service server 3 (S230). When requesting activation and inactivation of a random service capability, the above process is performed and a corresponding request may be processed.

Further, when deleting individual service capability information, the open service application server 3 requests deletion of individual service capability information by the service capability management apparatus 1 using a DELETE method of a defined resource (S240). The open service application server 3 transmits a message including an identifier of a service capability to update, and a deletion request of an individual service capability is performed.

When a request message using a DELETE method is received, the service capability management apparatus 1 deletes corresponding service capability information through the service capability providing server 5. The service capability management apparatus 1 transmits a deletion result to the open application service server 3 (S250).

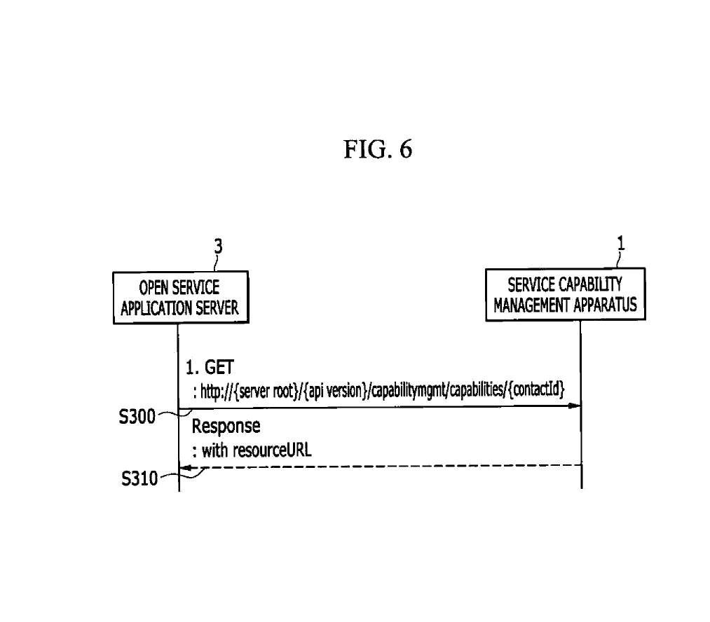

FIG. 6 is a flowchart illustrating a method of managing a service capability according to a third exemplary embodiment of the present invention.

Here, a process of inquiring about service capability information of contact based on a third resource (capabilities for a contact resource), which is a service capability information list R3 of contact, will be described.

As shown in FIG. 6, the open service application server 3, which is a website on the network 2, may request service capability information of contact from the service capability management apparatus 1, which is an open service gateway, and receive a service corresponding thereto, and a corresponding process may be performed according to a request of a random application of the open service application server 3.

The open service application server 3 requests a service capability inquiry of contact from the service capability management apparatus 1 using a GET method, which is a first method of a defined resource (S300), as shown Table 1. Here, a request message includes ID of contact to inquire such as “http://{serverroot}/{apiversion}/capabilitymgmt/capabilitiesSI(contactId)”.

The service capability management apparatus 1 receives a request message from the open service application server 3, receives information regarding a service capability corresponding to the received request from the service capability providing server 5, and transfers an inquiry result to the open service application server 3 (S310). Thereafter, the open service application server 3 receives an inquiry result including a URL that is related to service capability information of contact of which the inquiry is requested.

According to an exemplary embodiment of the present invention, application service logic that is connected to a network can provide and manage various service capabilities through a service capability management apparatus operating as a gate apparatus based on an interface that a communication network provider opens.

Further, management such as inquiry, update, deletion, and generation of a service capability can be easily performed through wired and wireless networks using an open interface using a RESTful web service.

In addition, IT field persons having no technical knowledge of a communication network can easily develop IT-based new service logic that can control a communication network through an open interface for a RESTful web service.

An exemplary embodiment of the present invention may not only be embodied through the above-described apparatus and/or method, but may also be embodied through a program that executes a capability corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of providing service capability management to a service application server that is connected to a user terminal through a network, the method comprising:
receiving, by a service capability management apparatus, a service capability management request for a communication network resource from the service application server; and
transmitting, by the service capability management apparatus, a request processing result comprising a uniform resource locator (URL) that is related to a processing result of a corresponding communication network resource to the service application server according to the request,
wherein the service capability management apparatus communicates with the service application server through an open interface using a representational state transferful (RESTful) web service.

2. The method of claim 1, wherein the transmitting of a request processing result comprises:
transferring, by the service capability management apparatus, the request to a service capability providing server of a communication network;
receiving, by the service capability management apparatus, a URL that is related to the processing result from the service capability providing server; and
transmitting, by the service capability management apparatus, a request processing result comprising a URL that is related to a processing result to the service application server.

3. The method of claim 1, wherein the communication network resource is a resource for service capability management open service through the service capability management apparatus, and comprises a first resource, which is a service providing capability information list, a second resource, which is individual service providing capability information, and a third resource, which is a service providing capability information list of contact.

4. The method of claim 3, wherein the transmitting of a request processing result comprises at least one of:
transmitting, by the service capability management apparatus, an inquiry result including a URL of an entire service capability information list that is provided through the service capability providing server to the service application server, when receiving a service capability management request using a first method for the first resource;
generating, by the service capability management apparatus, new service capability information through the service capability providing server and transmitting a processing result comprising an identifier and a related URL of the generated service capability information to the service application server, when receiving a service capability management request using a second method for the first resource;
updating, by the service capability management apparatus, corresponding service capability information through the service capability providing server and transmitting a processing result comprising a related URL of the updated service capability information to the service application server, when receiving the service capability management request using a third method for the first resource; and
deleting, by the service capability management apparatus, corresponding service capability information through the service capability providing server and transmitting a deletion result to the service application server, when receiving a service capability management request using a fourth method for the first resource.

5. The method of claim 3, wherein the transmitting of a request processing result comprises at least one of
transmitting, by the service capability management apparatus, an inquiry result including a URL of corresponding service capability information through the service capability providing server to the service application server, when receiving a service capability management request using a first method for the second resource;
updating, by the service capability management apparatus, corresponding service capability information through the service capability providing server and transmitting a processing result comprising a related URL of the updated service capability information to the service application server, when receiving a service capability management request using a third method for the second resource; and
deleting, by the service capability management apparatus, corresponding service capability information through the service capability providing server and transmitting a deletion result to the service application server, when receiving a service capability management request using a fourth method for the second resource.

6. The method of claim 5, further comprising performing, by the service capability management apparatus, activation and inactivation of corresponding service capability information, when receiving a service capability management request using the third method.

7. The method of claim 5, wherein the transmitting of a request processing result comprises transmitting, by the service capability management apparatus, an inquiry result comprising a URL of service capability information for corresponding contact to the service application server through the service capability providing server to the service application server, when receiving a service capability management request using a first method for the third resource.

8. A service capability management apparatus that provides service capability management to a service application server that is connected to a user terminal through a network, the service capability management apparatus comprising:
a web service processor that communicates with the service application server through an open interface using a representational state transferful (RESTful) web service and that receives a service capability management request of a communication network resource from the service application server and that transmits a processing result of the request to the service application server; and
a capability management processor that transfers the service capability management request to a service capability providing server that is located at a communication network and that receives a uniform resource locator (URL) that is related to a processing result of the request to transfer the URL to the web service processor,
wherein the web service processor provides the processing result of the request comprising the URL to the service application server.

9. The service capability management apparatus of claim 8, wherein the communication network resource is a resource for service capability management open service through the service capability management apparatus and comprises a first resource, which is a service providing capability information list, a second resource, which is individual service providing capability information, and a third resource, which is a service providing capability information list of contact.

10. The service capability management apparatus of claim 9, wherein the capability management processor comprises:
a management server unit that generates and registers an object for processing a request according to the request of the open service application server;
a protocol stack implementation unit that transfers the request to the service capability providing server by interlocking with the service capability providing server and that receives a processing result; and
a management implementation unit that operates by an object that is generated by the management server unit and that transfers the request to the protocol stack implementation unit and that receives the processing result from the protocol stack implementation unit to provide the processing result to the web service processor.

11. The service capability management apparatus of claim 10, wherein the service capability management request comprises at least one of a first method that requests an inquiry of the first resource, a second method that requests generation of the first resource, a third method that requests update of the first resource, and a fourth method that requests deletion of the first resource, when the service capability management request for the communication network resource is a request for the first resource.

12. The service capability management apparatus of claim 11, wherein the service capability management request comprises at least one of a first method that requests an inquiry of the second resource, a third method that requests update of the second resource, and a fourth method that requests deletion of the second resource, when the service capability management request of the communication network resource is a request for the second resource.

13. The service capability management apparatus of claim 11, wherein the service capability management request comprises a first method that requests an inquiry of the second resource, when the service capability management request for the communication network resource is a request for the third resource.

14. The service capability management apparatus of claim 8, wherein the service capability management apparatus is an open service gateway apparatus for providing service capability management of the application server.
